(19) United States
(12) Patent Application Publication
(10) Pub. No.: US 2017/0368727 A1
(43) Pub. Date: Dec. 28, 2017

(54) MASKLESS METHOD OF PRODUCING A COMPONENT HAVING A TWO-DIMENSIONAL APPEARANCE

(71) Applicant: FORD GLOBAL TECHNOLOGIES, LLC, Dearborn, MI (US)

(72) Inventors: LaRon Michelle Brown, Commerce Township, MI (US); Timothy Scott Stinson, Livonia, MI (US)

(21) Appl. No.: 15/193,547

(22) Filed: Jun. 27, 2016

(51) Int. Cl. B29C 45/00; B62D 29/00; B29C 45/16; B29C 45/40; B62D 25/08; B29L 9/00; B29K 69/00; B29L 31/30

(52) U.S. Cl. CPC B29C 45/0053; B29C 45/40; B62D 29/001; B62D 25/08; B29C 45/16; B29C 2045/0079; B29K 2069/00; B29L 2031/30; B29L 2009/005

(57) ABSTRACT

A method is provided of producing a component part for a motor vehicle. That method includes the steps of molding a first portion of an integral body from a chrome-platable material and molding a second portion of the integral body from a molded-in-color, non-platable material. This is followed by the applying of a chrome plate layer to the chrome-platable material. A component part or exterior grille made without masking and painting steps is also disclosed.

### TECHNICAL FIELD

This document relates generally to the component production field and, more particularly, to a method of producing a component having a two-dimensional or two-tone appearance wherein a first portion of the component has a chrome appearance and a second portion is a chosen color. The method eliminates any need to mask or paint the component to achieve this visual effect.

### BACKGROUND

It is desired to provide a two-dimensional or two-tone appearance to various component parts of a motor vehicle including, for example, an exterior grille. In the past this has required masking one portion of the component while the other portion is being chrome plated and then masking the chrome plated portion of the component while the other portion is being painted. Unfortunately, these multiple processing steps are relatively time consuming and significantly increase component production costs.

This document relates to a new and improved method of producing a component having the desired two-dimensional appearance without the need to complete any masking or painting steps. As such, the present method represents a significant advance in the art that reduces both production time and production costs when producing a component with a two-dimensional appearance.

### SUMMARY

In accordance with the purposes and benefits described herein, a component part is provided for a motor vehicle. That component part comprises an integral body including a first portion made from a chrome-platable material and a second portion made from a molded-in-color, non-platable material. The component part also includes a chrome plate layer on the first portion of chrome-platable material.

The chrome-platable material may be selected from a group of materials consisting of acrylonitrile butadiene styrene, polycarbonate/acrylonitrile butadiene styrene, polyamide, nylon and mixtures thereof. The molded-in-color, non-platable material may be a molded-in-color polycarbonate material or any non-butadiene containing polymers. That molded-in-color polycarbonate material may consist of multiple shades of color. Further, the component part may be an exterior grille for a motor vehicle.

In accordance with an additional aspect, a method is provided of producing a component part for a motor vehicle. That method comprises the steps of: (a) molding a first portion of the component part from a chrome-platable material in a first mold cavity, (b) molding a second portion of the component part from a molded-in-color, non-platable material in a second mold cavity thereby creating an integral body from the first and second portions, (c) removing that integral body from the second mold cavity and (d) applying a chrome plate layer to the chrome-platable material of the first portion.

The method may further include the step of injecting the chrome-platable material into the first mold cavity. The method may further include the step of injecting the molded-in-color, non-platable material to second mold cavity.

In addition, the method may include the step of opening the mold and removing the integral body from the mold. Further, the method may include the step of immersing the integral body into a bath of chrome plating solution until the chrome plate layer is formed on the chrome-platable material.

Still further, the method may include the step of removing the integral body from the bath of chrome plating solution. In addition the method may include the step of providing a finished component having a first portion covered in a chrome layer and a second portion in a chosen color while eliminating (a) a first masking step prior to chrome plating, (b) a second masking step prior to painting and (c) the actual painting of the component part.

In accordance with yet another aspect, a method is provided of producing an exterior grille for a motor vehicle. That method comprises the steps of (a) producing an integral body having a first portion made from a chrome-platable material and a second portion made from a molded-in-color, non-platable material and (b) applying a chrome layer to the first layer without masking the second portion. Further, the method may include the step of using a molded-in-color, non-platable material of a chosen color and eliminating paint masking and painting steps to produce the exterior grille with a first portion in chrome and a second portion in the chosen color.

In the following description, there are shown and described several preferred embodiments of the production method and the component part produced by that method. As it should be realized, the production method and component part are capable of other, different embodiments and their several details are capable of modification in various, obvious aspects all without departing from the production method and component part as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the production method and component part and together with the description serve to explain certain principles thereof. In the drawing figures:

FIG. 1 is a fragmentary view of a component part or exterior grille for a motor vehicle having a two-dimensional or two-tone appearance.

FIG. 2 is a detailed view of a portion of the exterior grille illustrated in FIG. 1.

FIG. 3 is a cross-sectional view taken along line 3-3 of FIG. 2.

FIGS. 4a-4g are a series of schematic illustrations showing the step-by-step method of producing the component part illustrated in FIGS. 1-3.

Reference will now be made in detail to the present preferred embodiments of the component part and the method of making the component part, examples of which are illustrated in the accompanying drawing figures.

### DETAILED DESCRIPTION

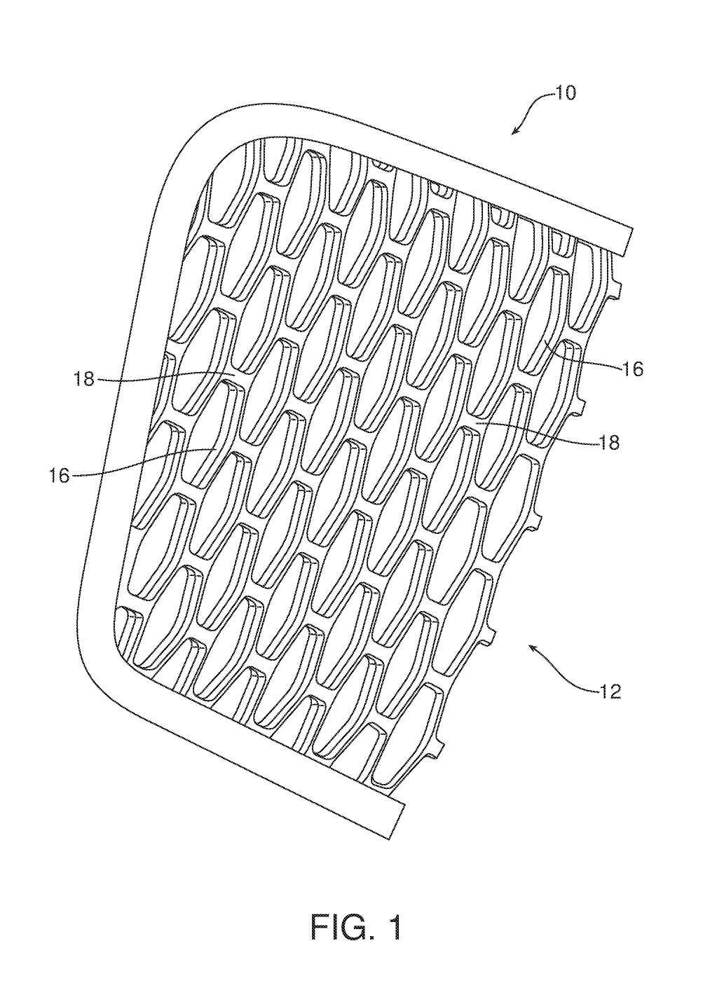

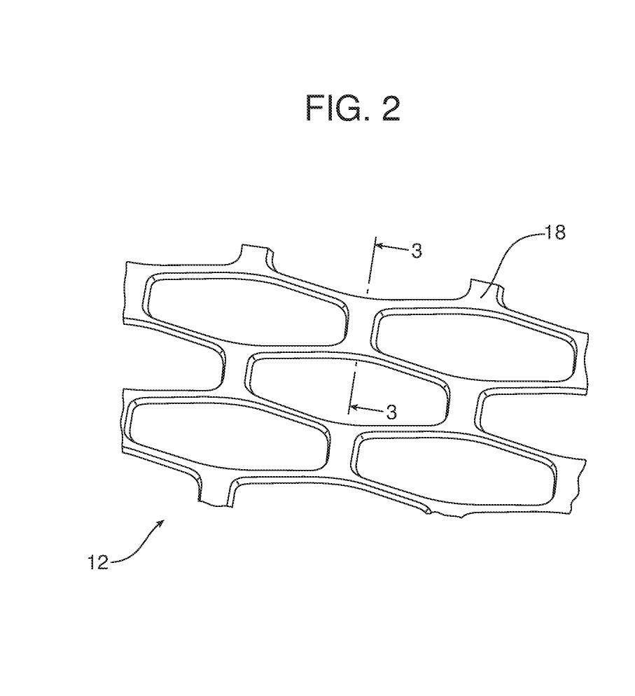

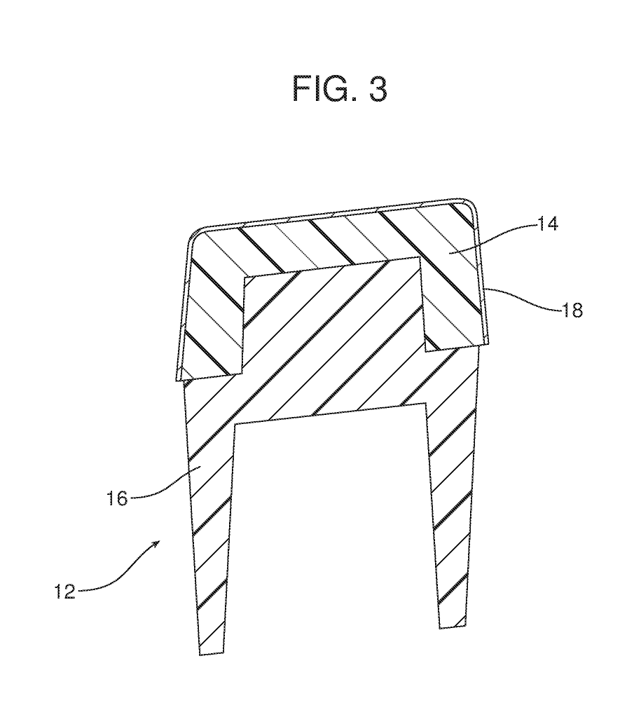

Reference is now made to FIGS. 1-3 illustrating a component part 10 for a motor vehicle. In the illustrated embodiment, the component part 10 comprises an exterior grille. As best illustrated in FIGS. 2 and 3, the component part/exterior grille 10 includes an integral body 12 having a first portion 14 made from a chrome-platable material and a second portion 16 made from a molded-in-color, non-platable material. A chrome plate layer 18 is provided on the surface of the first portion 14.

As should be appreciated, the component part/exterior grille 10 is characterized by having an A surface (i.e. the chrome plate 18) having a chrome appearance and a B surface (second portion 16) of a chosen color.

The chrome-platable material utilized to make the first portion 14 of the integral body 12 may be selected from a group of materials including, but not necessarily limited to, acrylonitrile butadiene styrene, polycarbonate/acrylonitrile butadiene styrene, polyamide, nylon and mixtures thereof. The molded-in-color, non-platable material from which the second portion 16 is made may be made from a molded-in-color polycarbonate material. Here it should be noted that molded-in-color polycarbonate material is presented as a single example of the type of material that may be utilized but is not limiting in scope.

The second portion 16 made from the molded-in-color, non-platable material may have a high gloss surface that is particularly resistant to chrome plating. In some of the many possible embodiments, the second portion 16 of molded-in-color, non-platable material may consist of multiple shades of color in order to provide a most unique aesthetic appearance in conjunction with the chrome-like A surface provided by the chrome plate layer 18 received on and bound to the first portion 14 of the integral body 12.

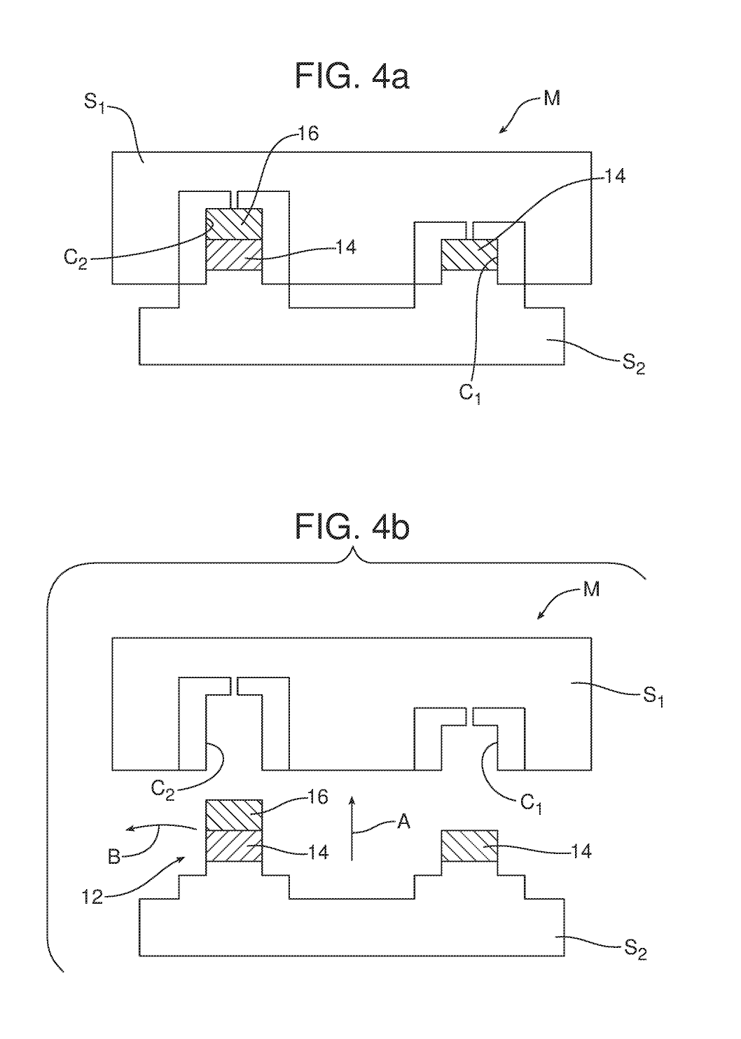

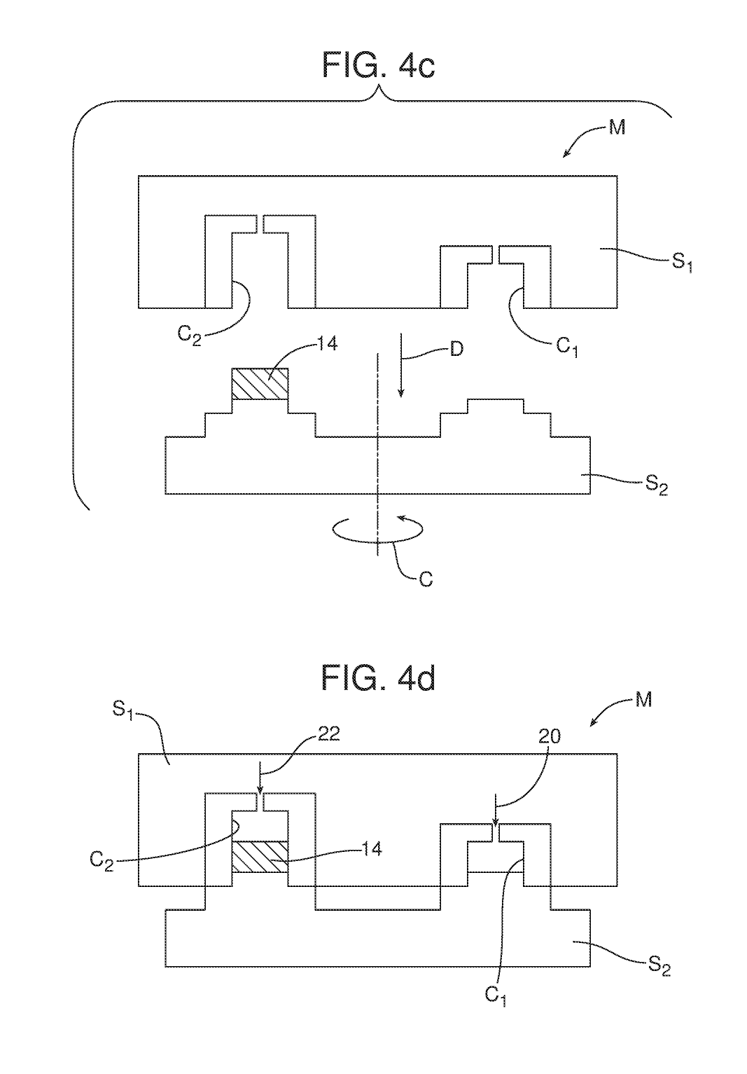

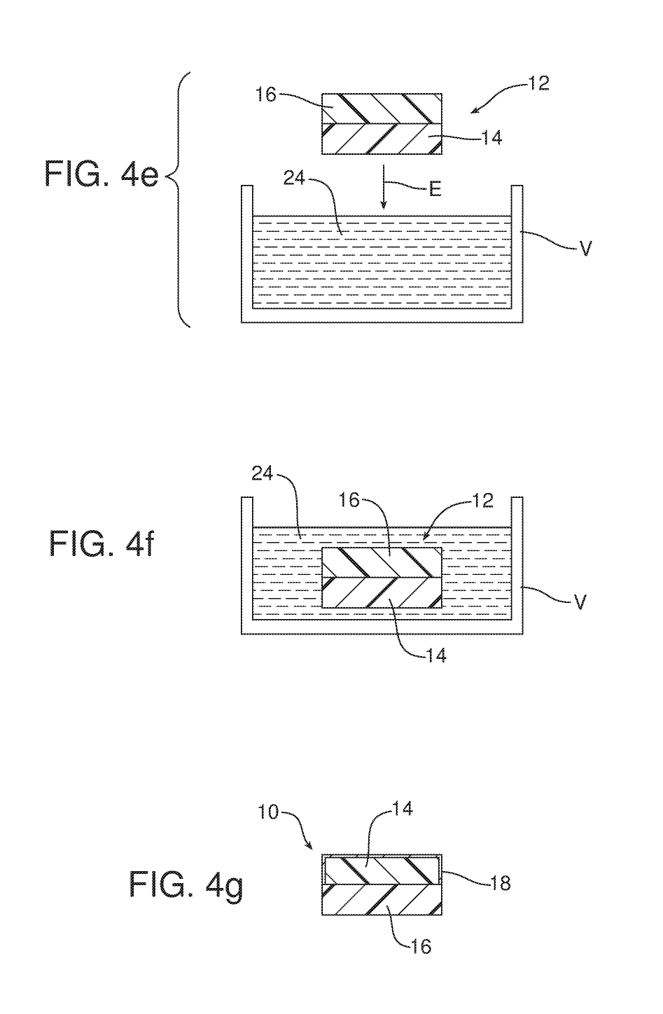

Reference is now made to FIGS. 4a-4g which schematically illustrate a method of producing the component part/exterior grille 10. As will become apparent from the following description, that method includes the steps of: (a) molding the first portion 14 of the integral body 12 from a chrome-platable material in a first mold cavity C₁, (b) molding the second portion 16 of the integral body from a molded-in-color non-platable material in a second mold cavity C₂ and (c) applying a chrome plate layer 18 to the chrome-platable material of the first portion. Advantageously, that method offers significant design appearance flexibility by enabling multiple finishes from a single mold M without having to do conventional masking and painting.

As illustrated in FIGS. 4a-4d, a mold M includes a first section S₁ and a second section S₂ which define a first mold cavity C₁ and a second mold cavity C₂. As illustrated in FIG. 4a, the mold M is closed. The first mold cavity C₁ holds a molded first portion 14 of the integral body 12 and the second mold cavity C₂ holds a fully molded integral body 12 including the first and second portions 14, 16.

As illustrated in FIG. 4b, the mold M is opened by raising the first section S₁ from the second section S₂ (note action arrow A). The finished, integral body 12 is then removed from the mold (note action arrow B).

As illustrated in FIG. 4c, the second mold section S₂ is then rotated 180° so that the molded first section 14 is aligned with the second mold cavity C₂ (see action arrow C). The mold M is then closed by lowering the first mold section S₁ (note action arrow D).

As illustrated in FIG. 4d, the chrome-platable material 20 is then injected into the first mold cavity C₁ to form the first portion 14 and the molded-in-color, non-platable material 22 is injected into the second mold cavity C₂ to form the second portion 16 and thereby create the integral body 12. The molding process then cycles back to the steps illustrated and described in FIG. 4a. This molding process is repeated as necessary to produce the desired number of component parts/exterior grilles 10.

The finished integral bodies 12 removed from the mold in FIG. 4b are then subjected to plating. Thus, the method includes applying a chrome plate layer 18 to the chrome-platable material 20 which now forms the first portion 14 of the integral body 12. As illustrated in FIG. 4e, this may be done by immersing the integral body 12, including the first portion 14 made from the chrome-platable material 20 and the second portion 16 made from the molded-in-color, non-platable material 22, into a bath or vessel V of chrome plating solution 24 (note action arrow E). The integral body 12 is maintained in the bath or vessel V of chrome plating solution 24 until the chrome plate layer 18 of desired thickness is formed on the chrome-platable material 20 which comprises the first portion 14 of the integral body 12 (see FIG. 4f). The integral body 12 is then removed from the bath or vessel V of chrome plating solution 24 and the chrome plating solution is allowed to drip from the molded-in-color, non-platable material 22 of the second portion 16. Thus, it should be appreciated that the method provides a finished component part or exterior grille 10 having a first portion 14 covered in a chrome layer 18 and a second portion 16 in a chosen color.

Advantageously, this is accomplished while eliminating all masking and painting steps. This includes eliminating the first masking step previously required prior to chrome plating as well as the second masking step previously required prior to painting. As such, it should be appreciated that the present method provides a simpler and faster production method which reduces both production time and production cost and thereby represents a significant advance in the art.

Consistent with the above description, a method is also provided for producing an exterior grille or component part 10 wherein that method comprises the steps of producing an integral body 12 having a first portion 14 made from a chrome-platable material 20 and a second portion 16 made from a molded-in-color, non-platable material 22 and applying a chrome layer 18 to the first portion without masking the second portion. Further, the method may be described as including the step of using a molded-in-color, non-platable material 22 of a chosen color and eliminating paint masking and painting steps to produce the exterior grille or component part 10 with a first portion 14 in chrome and a second portion in the chosen color.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A component part for a motor vehicle, comprising:
an integral body including a first portion made from a chrome-platable material and a second portion made from a molded-in-color, non-platable material; and
a chrome plate layer on said first portion.

2. The component part of claim 1, wherein said chrome-platable material is selected from a group of materials consisting of acrylonitrile butadiene styrene, polycarbonate/acrylonitrile butadiene styrene, polyamide, nylon and mixtures thereof.

3. The component part of claim 2, wherein said molded-in-color, non-platable material is a molded-in-color polycarbonate material.

4. The component part of claim 3, wherein said molded-in-color polycarbonate material consists of multiple shades of color.

5. The component part of claim 3, wherein said component part is an exterior grille.

6. The component part of claim 1, wherein said component part is an exterior grille.

7. A method of producing a component part for a motor vehicle, comprising:
molding a first portion of the component part from a chrome-platable material in a first mold cavity;
molding a second portion of the component part from a molded-in-color, non-platable material in a second mold cavity thereby creating an integral body from said first portion and said second portion;
removing said integral body from said second mold cavity; and
applying a chrome plate layer to said chrome-platable material of said first portion.

8. The method of claim 7 including injecting said chrome-platable material into said first mold cavity.

9. The method of claim 8 including injecting said molded-in-color, non-platable material into said second mold cavity.

10. The method of claim 9, further including opening said mold and removing said integral body from said mold.

11. The method of claim 10, further including immersing said integral body into a bath of chrome plating solution until said chrome plate layer is formed on said chrome-platable material.

12. The method of claim 11, further including removing said integral body from said bath of said chrome plating solution.

13. The method of claim 12, further including providing a finished component having a first portion covered in a chrome layer and a second layer in a chosen color while eliminating (a) a first masking step prior to chrome plating, (b) a second masking step prior to painting and (c) painting.

14. A method of producing an exterior grille for a motor vehicle, comprising:
producing an integral body having a first portion made from a chrome-platable material and a second portion made from a molded-in-color, non-platable material;
applying a chrome layer to said first portion without masking said second portion.

15. The method of claim 14, including using a molded-in-color, non-platable material of a chosen color and eliminating paint masking and painting steps to produce said exterior grille with a first portion in chrome and a second portion in said chosen color.
